(19) United States
(12) Patent Application Publication
(10) Pub. No.: US 2012/0330645 A1
(43) Pub. Date: Dec. 27, 2012

(54) Multilingual Bluetooth Headset

(76) Inventors: Enrique D. Belisle, Los Angeles, CA (US); Berhanu Tassew, Los Angeles, CA (US)

(21) Appl. No.: 13/474,688

(22) Filed: May 17, 2012

Related U.S. Application Data
(60) Provisional application No. 61/519,319, filed on May 20, 2011.

(51) Int. Cl. G06F 17/28

(52) U.S. Cl. 704/3

(57) ABSTRACT

The invention provides a Multilingual Bluetooth Headset, equipping a cell phone for language translation and improves verbal communication on a global scale. The Multilingual Bluetooth Headset provides business professionals and ordinary consumers with an effective tool to facilitate bilingual verbal conversations. The Multilingual Bluetooth Headset is a Bluetooth equipped, hands free cellular telephone, which includes bidirectional language translation functionality.

### CLAIM OF PRIORITY

This patent application claims priority under 35 USC 119 (e) (1) from U.S. Provisional Patent Application Ser. No. 61/519,319 filed May 20, 2011, of common inventorship herewith entitled, “Multilingual Bluetooth Headset.”

### FIELD OF THE INVENTION

The present invention pertains to the field of Bluetooth headset applications, and more specifically to the field of a multilingual or language translation application for Bluetooth technology.

### BACKGROUND OF THE INVENTION

The prior art has put forth several designs for language translations for electronic devices. Among these are:

U.S. Pat. No. 7,272,377 to Richard Vandervoort Cox and Thomas M. Isaacson describes a system and method for providing a location-based translation service. The system. comprises a speech recognition module, a translator module, a speech synthesizer module, a processor with memory, a language module, and a language and location database module. A wireless network node receives the location of the wireless device through a wireless network-based location or through a GPS system and then compares the location of the wireless device to the language and location database. If the user takes the device into a predominantly Chinese speaking area in a city whose language is English, the network recognizes Chinese being spoken and updates the default language translation to Chinese, so when the user executes the language translation application, Chinese is the priority language source selected for translation.

U.S. Pat. No. 6,438,524 to Guangming Carl Shi describes a voice controlled foreign language translator implemented in a device such that a user speaks a phrase in their native language and the translator repeats the phrase in a foreign language. The user is provided a collection of predetermined foreign phrases which are stored in a device memory. If implementing speaker dependent voice recognition, the user must speak the phrase and train the device to correlate the native language phrase with the foreign language phrase prior to using the translation feature.

U.S. Pat. No. 6,266,642 to Alexander M. Franz and Keiko Horiguchi describes a method and portable apparatus for performing spoken language translation. A speech input is received comprising at least one source language in a natural spoken language and source expressions are displayed for selection. An output is synthesized from the translated target language source expressions.

None of these prior art references describe the present invention.

### SUMMARY OF THE INVENTION

It is an object of the present invention to provide a multilingual or language translation application for Bluetooth technology.

### BRIEF DESCRIPTION OF THE DRAWINGS

FIG. 1 is top perspective of an actual size of a hands free Bluetooth device with language translation functionality.

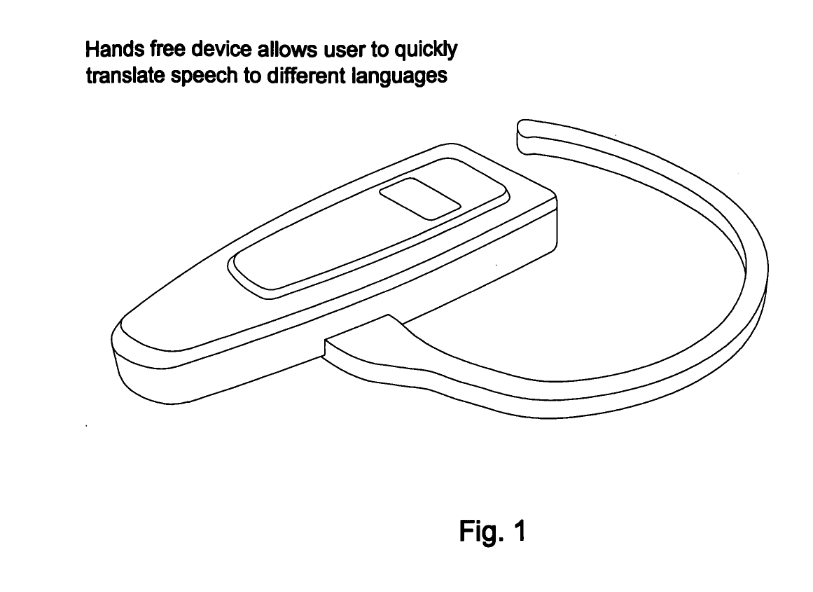

### DETAILED DESCRIPTION OF THE INVENTION

Before the current global age, communication for business dealings were usually conducted in person, face to face, and sealed with a handshake. Communication still is the very essence of human transactions and relations, but now business and relationships exist between people in different parts of the country and world and communication happens through phones and computers. Clear communication depends on both parties understanding what the other is saying. It is possible to have translators and interpreters present for meetings in person, but using the telephone does not offer that facilitation method.

The present invention, hereinafter referred to as the Multilingual Bluetooth Headset, equips a cell phone for language translation and improves verbal communication on a global scale. The Multilingual Bluetooth Headset provides business professionals and ordinary consumers with an effective tool to facilitate bilingual verbal conversations. The Multilingual Bluetooth Headset is a Bluetooth equipped, hands free cellular telephone, which includes bidirectional language translation functionality. The Multilingual Bluetooth Headset comprises a standard, fully featured, Bluetooth enabled cell phone with an earpiece including such features as a camera, a web browser, and texting. The Multilingual Bluetooth Headset initially translates English into Spanish and Spanish into English. Subsequent development plans are to expand the phone's capability for translation to a multitude of additional languages. The Multilingual Bluetooth Headset phone is equipped with hardware and software which functions in the manner of a universal translator, described as follows. When the user talks, their voice is detected by the device's voice recognition software. A customized speech and translation engine then determines what the person is saying and translates it into the preselected language of the listener. Within a few seconds after the English speaker finishes talking, the translated words are projected by the device's speaker to provide translation close to real time. Responses from the second speaker are translated back into English and projected in like fashion, such that bidirectional translation has occurred.

The Multilingual Bluetooth Headset possesses sophisticated voice recognition software, allowing for differences in the speaker's accent. It also possesses a dictionary stacking function, permitting users to add words, even jargon and slang, to the device's repertoire. With multiple language capability, the user scrolls down through the language offerings and selects the appropriate language for translation prior to making a call. The Multilingual Bluetooth Headset also can function in face to face interactions as a handheld translator, with each user speaking into the phone in turn. The present invention creates time and money savings without needing an interpreter for conversation and detailed emails and faxes that must be translated at the receiving end. The Multilingual Bluetooth Headset vastly expands the versatility and usefulness of cellular communication and is an extraordinarily efficient tool for both the international business community and for traveling and stay at home consumers.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A cell phone for language translation comprising multilingual or language translation application for Bluetooth technology, comprising hands free cellular telephone, which includes bidirectional language translation functionality, Bluetooth enabled cell phone with an earpiece including a camera, a web browser, and texting.

2. The cell phone for language translation of claim 1 comprising The Multilingual Bluetooth Headset capable of translation of English into Spanish and Spanish into English.

3. The cell phone for language translation of claim 1 comprising The Multilingual Bluetooth Headset capable of translation of other languages.

4. The cell phone for language translation of claim 1 comprising hardware and software which functions in the manner of a universal translator, described as follows: when the user talks, their voice is detected by the device's voice recognition software; a customized speech and translation engine then determines what the person is saying and translates it into the preselected language of the listener; within a few seconds after the English speaker finishes talking, the translated words are projected by the device's speaker to provide translation close to real time; responses from the second speaker are translated back into English and projected in like fashion, such that bidirectional translation has occurred.

5. The cell phone for language translation of claim 1, further comprising sophisticated voice recognition software, allowing for differences in the speaker's accent.

6. The cell phone for language translation of claim 1, further comprising a dictionary stacking function, permitting users to add words, even jargon and slang, to the device's database.
